(19) United States
(12) Patent Application Publication
(10) Pub. No.: US 2026/0046850 A1
(43) Pub. Date: Feb. 12, 2026

(54) IMPROVING RETURN LINK CAPACITY BY USING OVERLAPPING RETURN LINK CHANNELS

(71) Applicant: VIASAT, INC., Carlsbad, CA (US)

(72) Inventors: Sapna P. Mehta, San Diego, CA (US); Kaushik Chakraborty, San Diego, CA (US); Aniruddha Das, San Marcos, CA (US); Srikar Pottar, San Marcos, CA (US); Michail K. Tsatsanis, Huntington Beach, CA (US)

(73) Assignee: VIASAT, INC., Carlsbad, CA (US)

(21) Appl. No.: 19/101,359

(22) PCT Filed: Aug. 5, 2022
(86) PCT No.: PCT/US2022/039630

§ 371 Date: Feb. 5, 2025

(51) Int. Cl. H04W 72/0453

(52) U.S. Cl. CPC H04W 72/0453

(57) ABSTRACT

Described herein are systems and methods that improve or optimize return link capacity by employing overlapping return link channels in a return channel group (RCG) for a communications system shared by multiple user terminals. The disclosed technology enables different return link channel configurations to be used simultaneously while reducing or obviating the need for additional overhead messaging related to changing the configuration of the RCG. The disclosed technology allows for more efficient use of return link capacity by responding to changing conditions or demands in real time.

### BACKGROUND

### Field

The present disclosure generally relates to allocating transmit resources in a communications system.

### Description of Related Art

Network communications involve sending data back and forth between nodes, such as a content server and a user terminal. To send user data over a network, a scheduler can be used to allocate network resources to devices, creating a schedule of transmission for devices. Then, based on the schedule, the individual devices can transmit data using the allocated resources. Based on the schedule, a user terminal can transmit data to a gateway that is part of the communications system to be forwarded to a final destination.

### SUMMARY

In a first aspect, the present disclosure provides a method for communicating in a communications system. The method includes receiving a request for return link bandwidth from a first user terminal and from a second user terminal. The method also includes assigning a first return link channel to the first user terminal based at least in part on transmission characteristics of the first user terminal, the first return link channel selected from a plurality of return link channels grouped together in a return channel group, the first return link channel comprising a first frequency band. The method also includes assigning a first transmit grant time period to the first user terminal. The method also includes assigning a second return link channel to the second user terminal based at least in part on transmission characteristics of the second user terminal, the second return link channel selected from the plurality of return link channels in the return channel group, the second return link channel comprising a second frequency band. The method also includes assigning a second transmit grant time period to the second user terminal. The method also includes communicating the first return link channel, the first transmit grant time period, the second return link channel, the second transmit grant time period to the corresponding user terminal. The plurality of return link channels in the return channel group each have different transmission characteristics in which at least one return link channel has a frequency band that at least partially overlaps a frequency band of another return link channel.

In some embodiments of the first aspect, the first user terminal has a different transmission rate than the second user terminal.

In some embodiments of the first aspect, the method further includes determining whether the first frequency band at least partially overlaps with the second frequency band; and determining whether the first transmit grant time period at least partially overlaps with the second transmit grant time period. In further embodiments, the method further includes, responsive to determining that the first frequency band at least partially overlaps with the second frequency band and that the first transmit grant time period at least partially overlaps with the second transmit grant time period, assigning a third return link channel to the first user terminal, the third return link channel having a third frequency band that does not overlap with the second frequency band. In further embodiments, the method further includes, responsive to determining that the first frequency band at least partially overlaps with the second frequency band and that the first transmit grant time period at least partially overlaps with the second transmit grant time period, assigning a third transmit grant time period to the first user terminal wherein the third transmit grant time period does not overlap with the second transmit grant time period. In further embodiments, communicating assigned return link channels and transmit grant time periods to the first and second user terminals is responsive to determining that the first frequency band does not overlap with the second frequency band or that the first transmit grant time period does not overlap with the second transmit grant time period.

In some embodiments of the first aspect, the return channel group is hardcoded in the first user terminal and the second user terminal. In some embodiments of the first aspect, all possible return link channels of the communications system are included in the return channel group. In some embodiments of the first aspect, each return link channel in the return channel group has a common center frequency. In some embodiments of the first aspect, each return link channel in the return channel group has a common lower edge frequency.

In some embodiments of the first aspect, the method further includes periodically transmitting an return channel group (RCG) descriptor message to the first user terminal and to the second user terminal, the RCG descriptor message comprising an update to the return channel group. In further embodiments, the RCG descriptor message adds a return link channel to the return channel group, adjusts a center frequency of a return link channel in the return channel group, or adjusts a bandwidth of a return link channel in the return channel group.

In some embodiments of the first aspect, the first return link channel has a bandwidth that is greater than or equal to a transmission rate of the first user terminal and the second return link channel has a bandwidth that is greater than or equal to a transmission rate of the second user terminal. In some embodiments of the first aspect, channel conditions of the communications system deteriorate transmission characteristics of the first user terminal, and the first return link channel is assigned to the first user terminal based at least in part on the deteriorated transmission characteristics.

In a second aspect, the present disclosure provides for a communications system to provide communication over a network. The system includes a first user terminal having a first maximum bandwidth, the first user terminal configured to store a return channel group that comprises a plurality of return link channels. The system also includes a second user terminal having a second maximum bandwidth, the second user terminal configured to store the return channel group. The system also includes a gateway configured to communicate with the first user terminal and the second user terminal over the network. The gateway includes a scheduler configured to: store the return channel group; assign a first return link channel from the return channel group to the first user terminal based at least in part on the first maximum bandwidth, the first return link channel comprising a first frequency band; assign a first transmit grant time period to the first user terminal; assign a second return link channel from the return channel group to the second user terminal based at least in part on the second maximum bandwidth, the second return link channel comprising a second frequency band; assign a second transmit grant time period to the second user terminal; and communicate the first return link channel, the first transmit grant time period, the second return link channel, the second transmit grant time period to the corresponding user terminal. The plurality of return link channels in the return channel group each have different transmission characteristics in which at least one return link channel has a frequency band that at least partially overlaps a frequency band of another return link channel.

In some embodiments of the second aspect, the network comprises a satellite network with at least one low earth orbit satellite. In some embodiments of the second aspect, the network comprises a satellite network with at least one medium earth orbit satellite. In some embodiments of the second aspect, the network comprises a satellite network with at least one geosynchronous earth orbit satellite. In some embodiments of the second aspect, the network comprises a terrestrial network. In some embodiments of the second aspect, the network comprises a cellular network.

In some embodiments of the second aspect, the first maximum bandwidth is different from the second maximum bandwidth. In some embodiments of the second aspect, a duty cycle of the first user terminal is different from a duty cycle of the second user terminal.

In some embodiments of the second aspect, the first return link channel is assigned based at least in part on channel conditions that reduce a duty cycle of the first user terminal. In some embodiments of the second aspect, the first return link channel is assigned based at least in part on channel conditions that reduce the first maximum bandwidth.

In a third aspect, the present disclosure provides for a scheduler in a communications system. The scheduler includes a network interface configured to communicate with a first user terminal and a second user terminal over the communications system. The scheduler also includes a data store configured to store computer executable instructions for generating a return link schedule that allocates return link bandwidth to user terminals responsive to requests for return link bandwidth from the user terminals and to store a return channel group comprising a plurality of return link channels. The scheduler also includes a processor configured to execute the computer executable instructions to perform the following: assign a first return link channel from the return channel group to the first user terminal, the first return link channel comprising a first frequency band; assign a first transmit grant time period to the first user terminal; assign a second return link channel from the return channel group to the second user terminal, the second return link channel comprising a second frequency band; assign a second transmit grant time period to the second user terminal; and communicate the first return link channel, the first transmit grant time period, the second return link channel, the second transmit grant time period to the corresponding user terminal. The plurality of return link channels in the return channel group each have different transmission characteristics in which at least one return link channel has a frequency band that at least partially overlaps a frequency band of another return link channel.

In some embodiments of the third aspect, the processor is further configured to perform the following: determine whether the first frequency band at least partially overlaps with the second frequency band; and determine whether the first transmit grant time period at least partially overlaps with the second transmit grant time period. In further embodiments, responsive to determining that the first frequency band at least partially overlaps with the second frequency band and that the first transmit grant time period at least partially overlaps with the second transmit grant time period, the processor is further configured to assign a third return link channel to the first user terminal, the third return link channel having a third frequency band that does not overlap with the second frequency band. In further embodiments, responsive to determining that the first frequency band at least partially overlaps with the second frequency band and that the first transmit grant time period at least partially overlaps with the second transmit grant time period, the processor is further configured to assign a third transmit grant time period to the first user terminal wherein the third transmit grant time period does not overlap with the second transmit grant time period. In further embodiments, the processor is configured to communicate assigned return link channels and transmit grant time periods to the first and second user terminals responsive to determining that the first frequency band does not overlap with the second frequency band or that the first transmit grant time period does not overlap with the second transmit grant time period.

In some embodiments of the third aspect, all possible return link channels of the communications system are included in the return channel group.

In some embodiments of the third aspect, the processor is further configured to periodically transmit an RCG descriptor message to the first user terminal and to the second user terminal, the RCG descriptor message comprising an update to the return channel group. In further embodiments, the RCG descriptor message adds a return link channel to the return channel group, adjusts a center frequency of a return link channel in the return channel group, or adjusts a bandwidth of a return link channel in the return channel group.

For purposes of summarizing the disclosure, certain aspects, advantages and novel features have been described herein. It is to be understood that not necessarily all such advantages may be achieved in accordance with any particular embodiment. Thus, the disclosed embodiments may be carried out in a manner that achieves or optimizes one advantage or group of advantages as taught herein without necessarily achieving other advantages as may be taught or suggested herein.

### BRIEF DESCRIPTION OF THE DRAWINGS

Various embodiments are depicted in the accompanying drawings for illustrative purposes and should in no way be interpreted as limiting the scope of this disclosure. In addition, various features of different disclosed embodiments can be combined to form additional embodiments, which are part of this disclosure.

FIG. 1A illustrates a diagram of an example communications system that uses a satellite network and a scheduler to provide and manage communication between a plurality of user terminals and a plurality of gateway routing devices to provide access to a network (such as the Internet).

FIG. 1B illustrates another example communications system that includes an access network and a scheduler to provide and manage communication between a plurality of user terminals and a plurality of gateway routing devices to provide access to the Internet (or other suitable network).

FIG. 2A illustrates that each of the user terminals requests resource grants on the satellite network from the scheduler via the gateway routing device.

FIG. 2B illustrates that the scheduler allocates resource blocks (time-frequency resources) in one or more time slots to serve the resource requests from the user terminals.

FIG. 2C illustrates that the user terminals transmit data from their buffers in accordance with the time-frequency resources allocated by the scheduler.

FIG. 3A illustrates an example of a plurality of return channel groups (RCGs) that each do not include overlapping return link channels, the plurality of RCGs configured for use in certain communications systems.

FIG. 3B illustrates an example RCG channelization that provides overlapping return link channels, providing improved functionality relative to the RCG channelization sets of FIG. 3A.

FIG. 4A illustrates an example of an RCG with one return link channel that has a frequency band that overlaps two other return link channels.

FIG. 4B illustrates an example resource grant map that assigns different user terminals to different return link channels, the return link channels corresponding to the return link channels in the RCG of FIG. 4A.

FIG. 4C illustrates another example resource grant map.

FIG. 5A illustrates intra-slot allocations in a resource grant map.

FIG. 5B illustrates inter-slot allocations in a resource grant map.

FIG. 6 illustrates a flow chart of an example method of communicating on a communications system that supports return channel groups with overlapping channelization.

FIG. 7 illustrates a block diagram of an example scheduler configured to allocate resource grants to a plurality of user terminals using an RCG with overlapping channelization.

### DETAILED DESCRIPTION OF SOME EMBODIMENTS

The headings provided herein, if any, are for convenience only and do not necessarily affect the scope or meaning of the claimed embodiments.

### Overview

A communications system can concurrently communicate with multiple terminals on forward and return links. The forward link refers to the communication link from base stations to the terminals, and the return link refers to the communication link from the terminals to the base stations. Multiple terminals may simultaneously transmit data on the return link and/or receive data on the forward link. The number of terminals that may communicate with the communications system at any given moment may be constrained by the number of physical channels available for data transmission, which in turn is constrained by the available system resources.

Various return link channels can be defined to manage transmissions from the user terminals on the communications system. A return link channel may be defined by suitable transmission characteristics, such as a characteristic frequency (e.g., a center frequency, a lower edge frequency, an upper edge frequency, a frequency offset, etc.) and a bandwidth (e.g., a transmission rate). A return link channel can be defined to accommodate a particular transmission rate (e.g., symbol rate or chip rate). Thus, a user terminal can be allocated transmission resources by requesting resources and having assigned a return link channel to use for return link transmission during a transmission grant time period.

In some embodiments, multiple return link channels can be grouped into a return channel group (RCG). The RCG can include multiple return link channels to provide return link channels for a variety of transmission rates. In an RCG that is shared by multiple user terminals, return link channels may be defined to be sequential and non-overlapping to reduce or minimize interference and to increase or maximize capacity. An RCG defined in this way may minimize interference due at least in part to the frequency bands of the return link channels not overlapping with one another and may maximize capacity due at least in part to the frequency bands being sequential (e.g., the frequency bands of the return link channels are adjacent to each other).

The user terminals are allocated transmission resources on the return link using the return link channels from the RCG. The RCG can be communicated to the user terminals using messaging (e.g., an RCG descriptor message) that propagates a description of the set of return link channels for the RCG throughout the communications system. The messaging used to communicate the RCG can be accomplished using any suitable broadcast message that the communications system can use to transmit system information related to return link allocations to a plurality of user terminals.

If it is desirable to use an RCG with a different line-up of non-overlapping return link channels (e.g., to accommodate the arrival of a high data rate user terminal or due to a rain fade event), changes to the channel line-up must be propagated throughout the communications system which may take an undesirably long time (e.g., several minutes) to accomplish. The delay results from the process used to update the RCG, where the process may involve a network component (e.g., a scheduler) determining that it would be advantageous to change the RCG based on user traffic demand or varying channel conditions. The process then involves propagating the RCG to the user terminals using some over-the-air (OTA) message. Other components in the network (e.g., a physical layer processing module) may also need the updated RCG information to re-tune their components with the new channelization profile. The process may also include the user terminals adjusting their transmission chains to adapt to the new RCG. For example, the user terminals may need to refine their physical layer control loops to optimize their transmission parameters on the newly defined RCG. These steps in the process may also require one or more round trips over the wireless link. This process may take an undesirably long time and may exceed several minutes for a geosynchronous earth orbit satellite link, for example. This makes it challenging to quickly respond to changing conditions in the communications network that may affect the efficacy or desirability of the current RCG.

For example, situations may arise in which channel conditions may deteriorate (e.g., rain may adversely affect transmission capabilities in a satellite communications system). In such situations, it may be desirable to use a different RCG that includes more return link channels for lower transmission rates than are defined in the current RCG. This can be done to accommodate user terminals that fall to a lower transmission rate under such conditions. Otherwise, bandwidth may be assigned to user terminals that, due to the deteriorated channel conditions, are unable to utilize all of the assigned bandwidth resulting in decreased efficiency in the communications system. As another example, high-capacity user terminals may create sporadic demands for higher throughput return link traffic. In such situations, it may be desirable to use a different RCG that includes available return link channels for higher transmission rates which may not be defined in the current RCG. Otherwise, there is unused transmission capacity in the communications system.

In situations similar to these, it may take an undesirably long time to propagate a different RCG to the user terminals and other components of the communications system, as described herein. Accordingly, described herein are systems and methods that improve or optimize return link capacity by employing overlapping return link channels in an RCG for a communications system shared by multiple user terminals. The disclosed technology enables different return link channel configurations to be used simultaneously while reducing or obviating the need for additional overhead messaging related to changing the RCG. The disclosed technology allows for more efficient use of return link capacity by responding to changing conditions or demands in real time.

The disclosed systems and methods specify a plurality of return link channels in the communications system and defines the RCG to include each of these channels, wherein two or more of the channels overlap in frequency. In some embodiments, the RCG includes every return link channel that is possible in the communications system. In various implementations, the return link channels are defined in the RCG with a unique channel identifier and a frequency offset. In some embodiments, this RCG may be hardcoded in the code at both the user terminal and the scheduler or other component such as a base station or ground station. In certain embodiments, a periodic message is transmitted with a list of all the channels (including the overlapping channels) in the RCG. In such embodiments, the user terminals read the message to understand return link channelization as defined by the communications system. This can be done to retain flexibility by the communications system to change channelization, which may be beneficial as the network evolves and new channels are introduced.

Because the channels overlap in the disclosed RCGs, not all channels defined in the RCG can be used at the same time. Thus, a scheduler or other component in the communications system is configured to ensure that user terminals are scheduled in a non-overlapping manner. The non-overlapping time-frequency allocation avoids co-channel interference in certain communications systems, such as those that employ multi-frequency time-division multiple access (MF-TDMA). For example, if a user terminal is scheduled to transmit during a first time period on a first channel, then the scheduler is configured to not allow any other user terminal to transmit on a channel with a frequency band that overlaps the frequency band of the first channel during a time period that overlaps with the first time period.

Advantageously, the disclosed technology can obviate the need for channel reconfiguration algorithms or messaging due at least in part to the disclosed RCG including many or all possible channel configurations available in a communications system. Advantageously, the disclosed technology also allows for terminals of different capabilities to coexist in a communications system. For example, a terminal that can transmit at 160 Mcps (mega chips per second) can coexist with a terminal that can only transmit up to 10 Mcps with little or no waste in bandwidth. Furthermore, the disclosed technology advantageously also enables different combinations of communication capabilities to exist and be active on different aspects of the communications systems at the same time. For example, a first beam of a satellite could employ a channelization that enables transmissions at 160 Mcps while another beam of the satellite employs a channelization that does not include transmissions at 160 Mcps.

### Example Communications Systems

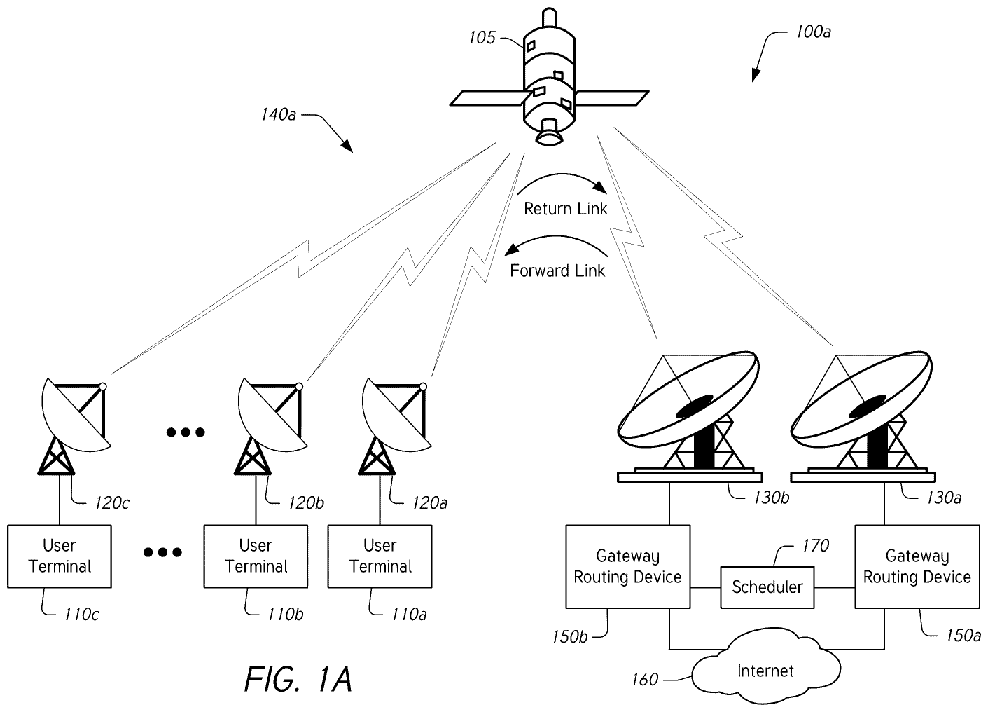

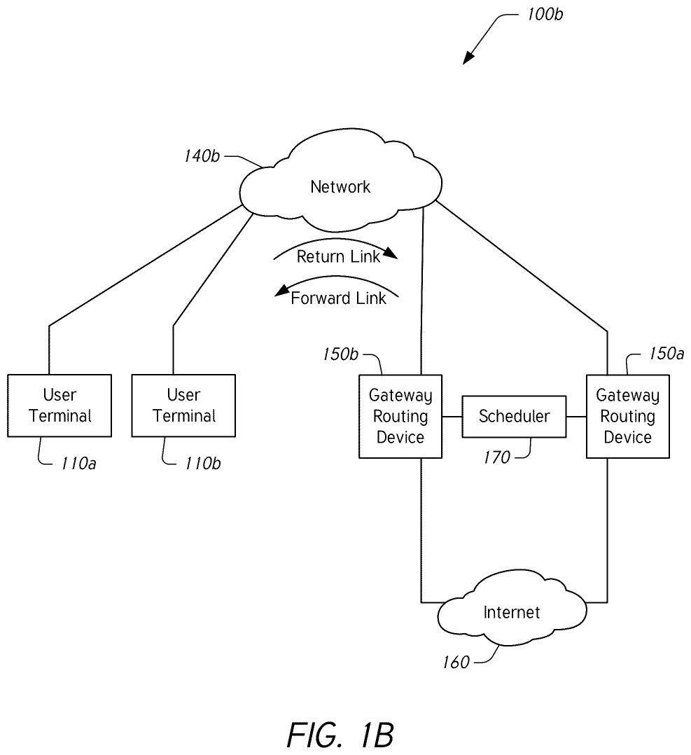

FIG. 1A illustrates a diagram of an example communications system 100a that uses a satellite network 140a to communicatively couple a plurality of user terminals 110a, 110b, 110c and a plurality of gateway routing devices 150a, 150b to one another to provide access to a network (such as the Internet 160). The communications system 100a includes a scheduler 170 configured to allocate resource grants to the user terminals 110a, 110b, 110c. The communications system 100a includes a plurality of gateway satellite transceivers 130a, 130b and a plurality of customer satellite transceivers 120a, 120b, 120c configured to transmit and receive signals through the satellite 105.

The communications system 100a may utilize various network architectures that include space and ground segments. The satellite network 140a incorporates these elements to provide communications between the plurality of user terminals 110a, 110b, 110c and the gateway routing devices 150a, 150b. For example, the space segment may include one or more satellites, while the ground segment may include one or more satellite user terminals, gateway terminals, network operations centers (NOCs), satellite and gateway terminal command centers, and/or the like. Some of these elements are not shown in the figure for the sake of clarity. The satellite network 140a can include a geosynchronous earth orbit (GEO) satellite or satellites, a medium earth orbit (MEO) satellite or satellites, and/or a low earth orbit (LEO) satellite or satellites. It should be understood that the satellite 105 may represent one or more satellites and that the one or more satellites may include GEO satellites, MEO satellites, LEO satellites, or any combination of these.

The user terminals 110a, 110b, 110c can include a router or other user equipment and can be configured to send and receive data routed over the communications system 100a. The user terminals 110a, 110b, 110c can include or be communicatively coupled to any type of consumer premises equipment (e.g., a telephone, modem, router, computer, set-top box, and the like). The user terminals 110a, 110b, 110c are configured to send and receive data using the satellite network 140a via respective customer satellite transceivers 120a, 120b, 120c. The customer satellite transceivers 120a, 120b, 120c can include an antenna that is a phased array, two antennas (e.g., one for transmission and one for receiving), or multiple antennas each accessing a different satellite or communication path.

The satellite network 140a provides a forward link for sending information from the gateway routing devices 150a, 150b to the user terminals 110a, 110b, 110c and a return link for sending information from the user terminals 110a, 110b, 110c to the gateway routing devices 150a, 150b. The forward link and return link may be referred to as over-the-air (OTA) signal or communication paths. The forward link includes a transmission path from the gateway routing devices 150a, 150b through a respective gateway satellite transceiver 130a, 130b, through a satellite 105 via a satellite uplink channel, to the customer satellite transceivers 120a, 120b, 120c via a satellite downlink channel, and to the user terminals 110a, 110b, 110c. The return link includes a transmission path from the user terminals 110a, 110b, 110c through the respective customer satellite transceivers 120a, 120b, and 120c through the satellite 105 via the satellite uplink channel, to the gateway satellite transceivers 130a, 130b via the satellite downlink channel, and to the gateway routing devices 150a, 150b. It is to be understood that each communication path may utilize multiple satellites and transceivers.

The scheduler 170 is configured to manage the allocation of communication resources to the user terminals 110a, 110b, 110c. The scheduler 170 can be part of the gateway routing devices 150a, 150b or it can be a separate component of the communications system 100a. In addition, communication resources may be managed by multiple components of the communications system 100a. In some embodiments, part or all of the gateway routing devices 150a, 150b and/or the scheduler 170 can be located in a virtual device residing in a public or private computing cloud and/or as a part of a distributed computing environment. The scheduler 170 can be configured to manage resources for the plurality of gateway routing devices 150a, 150b as well as the user terminals 110a, 110b, 110c.

In some embodiments, one or more of the user terminals 110a, 110b, 110c can be configured to communicate with different communications systems (e.g., satellite systems such as GEO satellites, MEO satellites, and/or LEO satellites; cellular systems such as Long Term Evolution (LTE) technology; and/or terrestrial systems such as digital subscriber lines (DSL)) using different customer satellite transceivers 120a, 120b, 120c. Thus, there can be multiple communication paths for a user terminal 110a, 110b, 110c between the user terminal and the Internet 160. In some embodiments, the communications system 100a (e.g., the scheduler 170) is configured to select a desirable, efficient, or optimal communication path for the user terminal 110a, 110b, 110c among the plurality of communication paths available to the user terminal.

As described herein, return link channels are grouped into a return channel group (RCG). The RCGs disclosed herein include a plurality of return link channels wherein at least one return link channel has a frequency band that overlaps with another return link channel. In some embodiments, the RCGs disclosed herein specify many or all possible return link channels available to the communications system 100a. Communications systems, such as the communications system 100a, have a finite number of channels that may be used in the system wherein the number of channels depends on various system limitations such as quantization of time and frequency, numerology of the system, etc. In certain implementations, the number of return link channels may be limited by the available frequency bands. As used herein, all possible return link channels in a communications system can be defined as the total number of return link channels available for use in the communications system, which depends on various system parameters. For example, a communications system may use an RCG that is defined in a licensed spectrum that is uniquely determined by its frequency span (e.g., parameterized by a lower-edge frequency, upper-edge frequency, and channel bandwidth). Given the frequency band, a simple channelization scheme for the return link channels within the RCG may involve a few parameters such as a minimum channel bandwidth and a scale factor. Within such a channelization scheme, each possible return link channel has a bandwidth of the form BW_min*SF\hat{ }n Mcps, where BW_min is the minimum channel bandwidth, SF is the scale factor, and n is a non-zero positive integer. Thus, it is possible to determine the set of all possible return link channels for a given scheme.

As a particular example, the communication system may use a 500 MHz channel in Ka-band spanning the frequency range of 21.0 GHz to 21.5 GHz with the minimum channel bandwidth (BW_min) being 5 Mcps and the scale factor (SF) being 2. The possible return link channels within such a scheme have a bandwidth of the form 5*2\hat{ }n Mcps. Since the RCG spans a maximum bandwidth of 500 MHZ, the largest return link channel bandwidth could be 320 Mcps. In other words, for this channelization scheme, the possible return channel bandwidths are 5, 10, 20, 40, 80, 160, and 320 Mcps. The set of all possible return link channels for this scheme, considering the bandwidth of the frequency range, includes 100 possible 5 Mcps channels, 50 possible 10 Mcps channels, 25 possible 20 Mcps channels, 12 possible 40 Mcps channels, 6 possible 80 Mcps channels, 3 possible 160 Mcps channels, and 1 possible 320 Mcps channel. In some embodiments, the overlapping channels of different bandwidth may have a common lower edge frequency. In various embodiments, the overlapping channels may have a common center frequency.

In some embodiments, the RCG is hardcoded in the scheduler 170 as well as in the user terminals 110a, 110b, 110c. In some embodiments, the RCG can be changed by the scheduler 170, and changes to the RCG can be communicated to the user terminals 110a, 110b, 110c and other components of the communications system 100a through RCG descriptor messages.

The scheduler 170 is configured to allocate transmission resources on the return link to the user terminals 110a, 110b, 110c using the RCG. For example, for each user terminal 110a, 110b, 110c requesting bandwidth on the return link, the scheduler 170 assigns a transmit grant time period and a return link channel from the RCG. The return link channel has an associated frequency and bandwidth (e.g., corresponding to a frequency band). The scheduler 170 can be configured to assign a return link channel to a particular user terminal based at least in part on the transmission characteristics of the corresponding user terminal. For example, a return link channel may be configured to accommodate a particular transmission rate (e.g., a symbol rate or a chip rate) and the scheduler 170 can be configured to assign the return link channel to a user terminal that is capable of achieving the particular transmission rate supported by the return link channel. For instance, the scheduler 170 can be configured to assign a return link channel with a bandwidth that accommodates a transmission rate of 80 Mcps to a user terminal that is capable of transmitting at 80 Mcps. The capabilities of a user terminal are affected by hardware components of the user terminal, such as filters and amplifiers, that impact transmission characteristics, such as power and bandwidth. The capabilities of a user terminal are also associated with parameters of the user terminal such as maximum power or terminal antenna performance/off axis, etc. The scheduler 170 is thus configured to assign return link channels based at least in part on the capabilities of the respective user terminals, the capabilities being affected by components that impact transmission characteristics.

In some embodiments, the scheduler 170 may assign different RCGs to different aspects of the communications system 100a, such as the satellite network 140a. For example, the schedule 170 may assign a first RCG having a first channelization scheme to a first communication link (e.g., beam) of the communications system 100a and a second RCG having a second channelization scheme different from the first channelization scheme to a second communication link. The different RCGs having the different channelization schemes could enable different devices to be able to communicate via the respective communication links at the same time.

For example, a first beam of the satellite network 140a may serve one or more user terminals 110 (stationary and/or mobile) capable of transmitting at 80 Mcps and 160 Mcps and may have assigned thereto the first RCG employing the first channelization scheme that enables device communications at both 80 and 160 Mcps. However, a second beam of the satellite network 140a may serve one or user terminals 110 (stationary and/or mobile) capable of transmitting at a maximum of 80 Mcps and may have assigned thereto the second RCG employing the second channelization scheme that does not enable device transmissions at greater than 80 Mcps. As such, the first RCG may comprise a first set or plurality of return link channels and the second RCG may comprise a second set or plurality of return link channels that is different from the first set or plurality of return link channels. Based on these first and second RCGs, the scheduler 170 may assign the user terminal 110a communicating via the first beam a return link channel with a bandwidth that accommodates the 160 Mcps according to the first RCG channelization scheme while the scheduler 170 assigns the user terminal 110b communicating via the second beam a return link channel with a bandwidth that accommodates only the 80 Mcps according to the second RCG channelization scheme. Thus, the scheduler 170 can configure various aspects (e.g., beams, paths, etc.) of the communications system 100a in different ways based on and as appropriate for characteristics of those aspects.

Based on the assignment from the scheduler 170, each user terminal that has been allocated resources transmits data during the assigned time period using the assigned return link channel. Scheduling the transmission of bursts on the return link may be determined ahead of time by the scheduler 170 based at least in part on aggregate demands of the user terminals 110a, 110b, 110c.

Thus, the scheduler 170 is configured to receive a resource request (e.g., a request for return link bandwidth) from each user terminal 110a, 110b, 110c. For each received resource request, the scheduler 170 is configured to determine a return link channel for the user terminal based at least in part on transmission characteristics of the user terminal. The scheduler 170 is then configured to communicate the determined return link channel along with an assigned transmit grant time period to the corresponding user terminal.

The scheduler 170 is configured to determine whether any allocated return link channels have overlapping frequency bands and overlapping transmit grant time periods. If the scheduler 170 determines that two resource grants overlap (e.g., the frequency bands at least partially overlap within a time period that at least partially overlaps), the scheduler 170 can reassign one resource grant to a different return link channel. This can be repeated until there are no overlapping resource grants. The scheduler 170 can be configured to allocate resource grants to various user terminals based on a variety of parameters such as, for example and without limitation, bandwidth requests, quality of service parameters of service flows (e.g., priority, guaranteed rates, latency, jitter, etc.), and/or waiting time of previous resource grants for the same user terminal or service flow in the scheduler queue. In some embodiments, the scheduler 170 is configured allocate a resource grant to the user terminal at the head of the scheduler queue and the scheduler 170 is then configured to mark the allocated resource grant (time/frequency resource) as used for subsequent allocations. This may reduce or eliminate the need to determine whether allocated resource grants overlap in time and frequency.

The scheduler 170 can then transmit the resource grants or schedule to the user terminals 110a, 110b, 110c. In some embodiments, the transmitted resource grants reference an index or other identifier of the return link channel to the corresponding user terminal. The user terminal can use the index or other identifier to look up the return link channel in the RCG stored at the user terminal to determine the relevant characteristics of the return link channel to enable transmission of bursts through the satellite network 140a.

The scheduler 170 is configured to separate in time the transmissions of two user terminals if the frequency bands of the two user terminals overlap. The scheduler 170 is configured to intelligently schedule transmission of return link channels that overlap in the frequency domain so that the transmissions do not overlap in the time domain. In this way, only one user terminal is allowed to transmit during a time period for a subset of overlapping return link channels (or channels that overlap in frequency band). Similarly, the scheduler 170 is configured to intelligently schedule transmission of return channels so that transmission allocations that overlap in the time domain do not overlap in the frequency domain. The scheduler 170 may implement any suitable technology to accomplish this scheduling, including but not limited to MF-TDMA technology.

The disclosed overlapping channelization techniques enable more efficient use of the over-the-air capacity on the return link, which may be particularly beneficial on a high-throughput broadband satellite system. As used herein, overlapping channelization can refer to the presence of return link channels with overlapping frequency bands in a single RCG that is used by a communications system to allocate transmission resources. In communications systems that utilize overlapping channelization, optimization schemes may be implemented that determine return link channel allocations that do not collide or interfere with one another. This is different from certain channelization schemes that utilize non-overlapping and/or sequential return link channels because such schemes do not include return link channels that interfere with one another. The disclosed overlapping channelization techniques enable more efficient use of return link capacity due at least in part to being able to allocate resources to correspond to transmission capabilities or needs of the user terminals in the system and to adapt to changes in those transmission capabilities or needs. Certain channelization techniques do not quickly respond to changing transmission capabilities or needs because such changes may require different RCG configurations to be implemented and propagated to the user terminals, which may take an undesirably long time (e.g., a few minutes) to implement and which may introduce network instability. Furthermore, with certain channelization techniques the scheduler does not decide that it would be beneficial to have a different channel configuration, but rather different RCG channel sets are selected based on predetermined criteria, and changes between sets happens over minutes. In contrast, the scheduler 170 is configured to determine which channel is suitable or optimal for each user terminal, the selection being from all of the possible channels indicated in the overlapping channelization configuration. As a result, different channel configurations can be implemented in real time and can be reverted in real time as well.

FIG. 1B illustrates another example communications system 100b that includes an access network 140b configured to communicatively couple the plurality of user terminals 110a, 110b to the Internet 160 (or other suitable network) through the gateway routing devices 150a, 150b that provide the functionality described herein with reference to FIG. 1A. The access network 140b can be a terrestrial network, a satellite network, a cellular network, or any combination of these networks. For example, the user terminals 110a, 110b may couple to the Internet 160 via the access network 140b comprising a combination of a satellite network and a cellular network. The scheduler 170 also provides the functionality described herein with reference to FIG. 1A. In other words, the scheduler 170 utilizes an RCG with overlapping return link channels to allocate transmission resources to the user terminals 110a, 110b. Thus, the communications system 100b can utilize the overlapping channelization technologies described herein and may benefit from the advantages provided by such technologies. The scheduler 170 is also configured to manage transmission resources among the user terminals 110a, 110b and the gateway routing devices 150a, 150b.

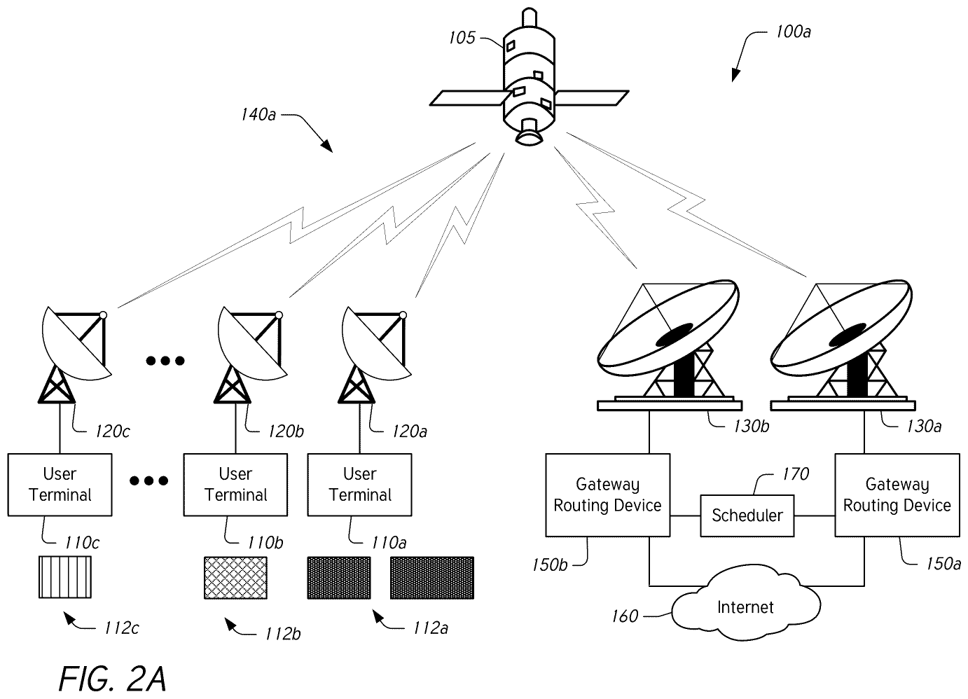

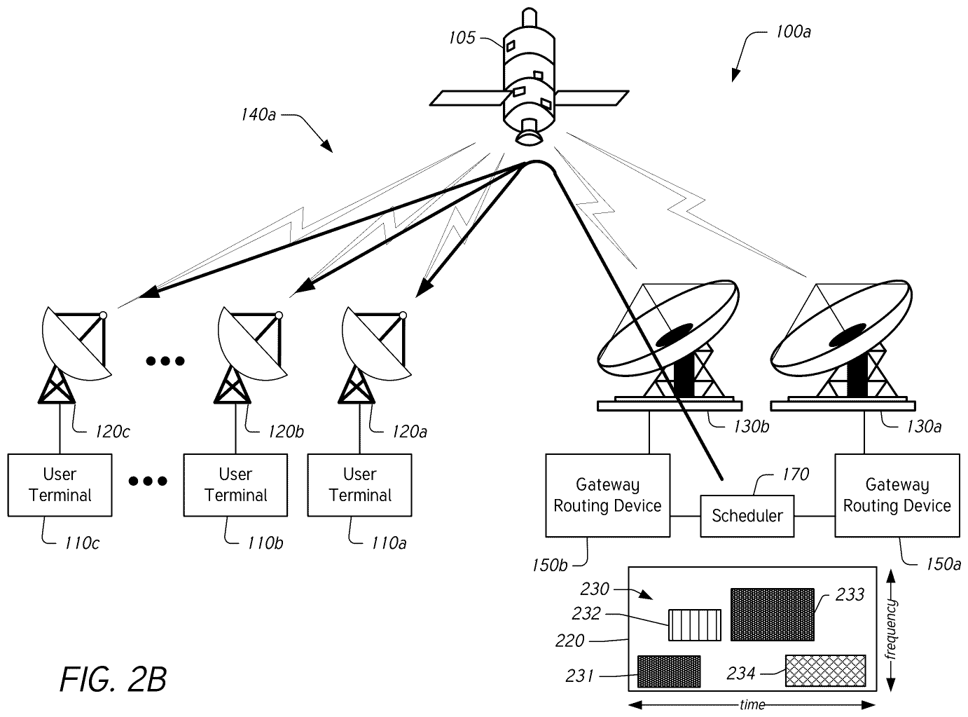

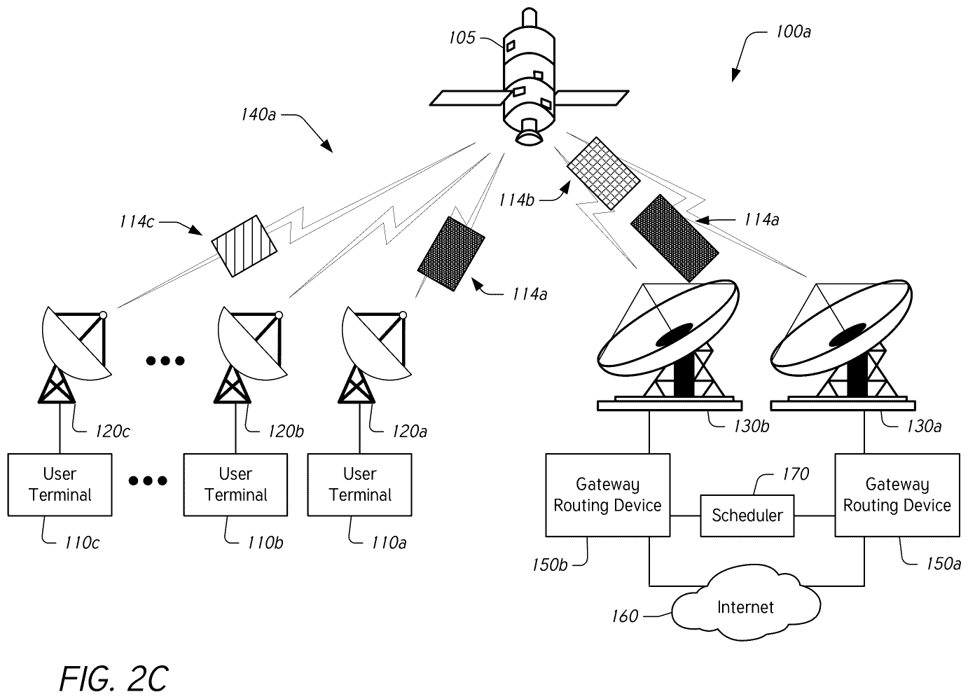

FIGS. 2A, 2B, and 2C illustrate an example of scheduling and transmitting bursts according to an allocated resource schedule in the communications system 100a of FIG. 1A. It should be noted that a similar procedure can be implemented in the communications system 100b of FIG. 1B. The procedure for allocating transmission resources in FIGS. 2A-2C advantageously utilizes the overlapping channelization technologies described herein.

FIG. 2A illustrates that each of the user terminals 110a, 110b, 110c requests resource grants 112a, 112b, 112c on the satellite network 140a from the scheduler 170 via the gateway routing devices 150a, 150b. The user terminals 110a, 110b, 110c request resource grants from the scheduler 170 based on buffer size, quality of service (QoS) parameters, and other flow parameters. Each of the user terminals 110a, 110b, 110c have associated transmission characteristics such as a transmission rate. The scheduler 170 can determine a return link channel based at least in part on the transmission characteristics of the user terminal.

FIG. 2B illustrates that the scheduler 170 allocates resource grants 230 (time-frequency resources) in one or more time slots, such as time slot 220, to serve the resource requests from the user terminals 110a, 110b, 110c. These allocations are based at least in part on the demands from the user terminals 110a, 110b, 110c as well as the transmission characteristics of the user terminals 110a, 110b, 110c. The allocation can be transferred to the user terminals 110a, 110b, 110c via the gateway routing devices 150a, 150b.

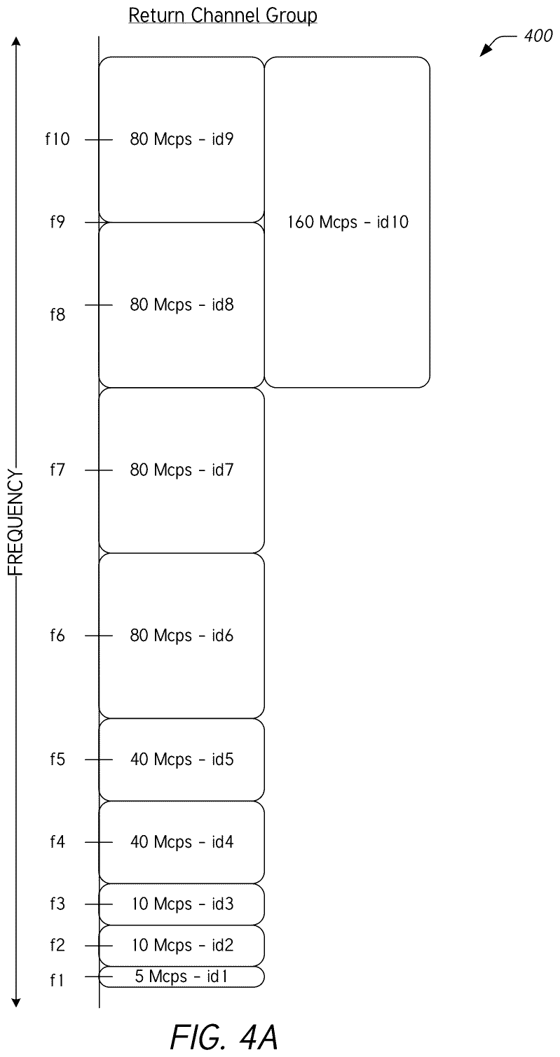

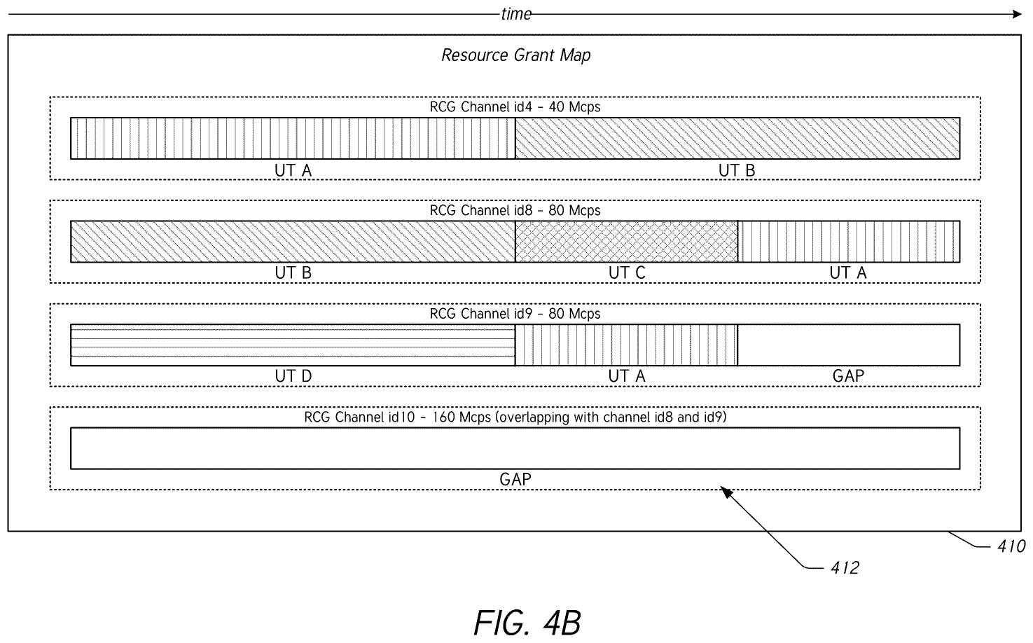

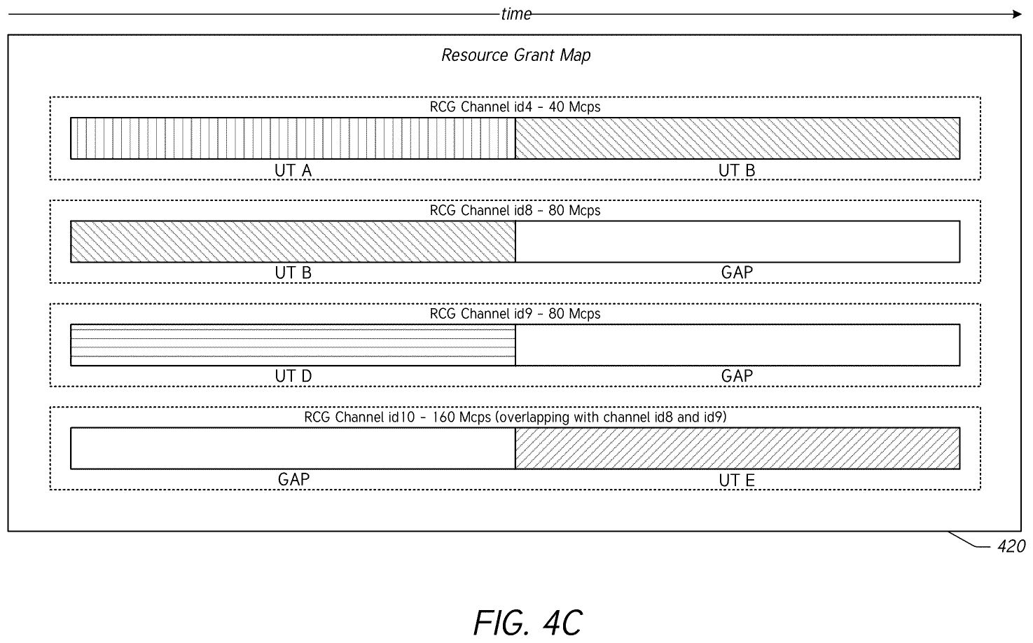

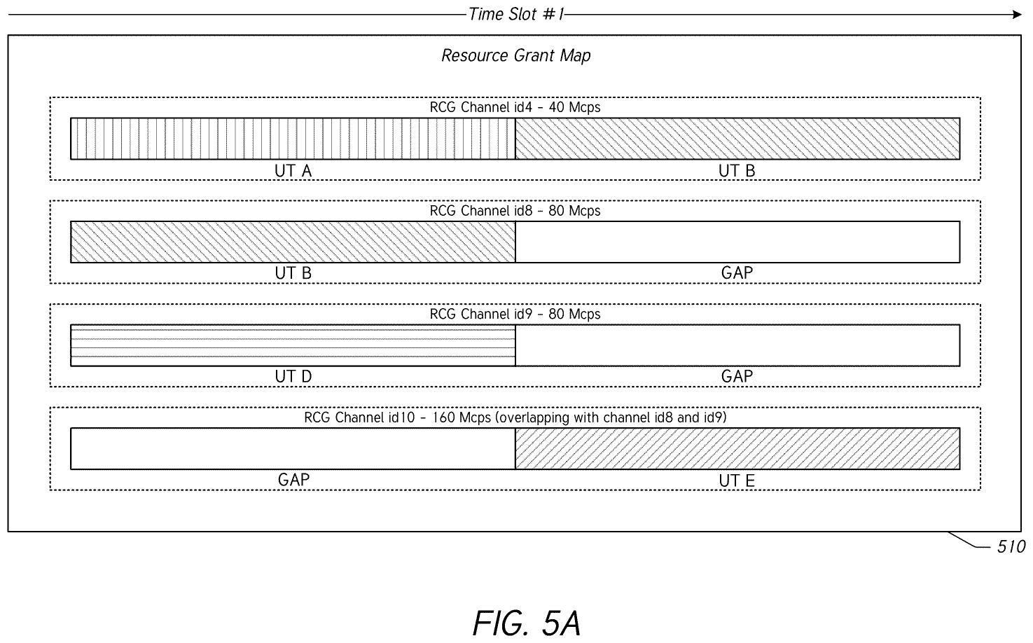

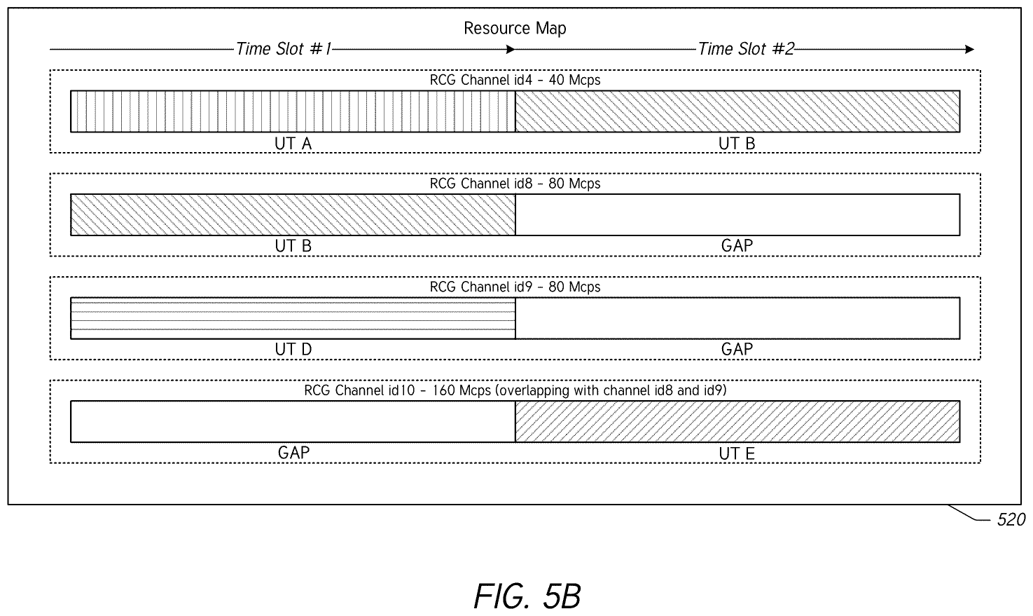

As shown in FIG. 2B, the scheduler 170 is configured to allocate resource grants 230 in the time slot 220 so that there is no overlap. An overlapping resource grant would be a resource grant that at least partially overlaps in frequency with another resource grant for at least a portion of a time period. Here, the scheduler 170 allocates resource grants 230 so that there is no overlap. The scheduler 170 is configured to allocate non-overlapping resource grants even though overlapping channels are defined in the RCG. The allocated resource grants 230 may use the same or overlapping frequency bands but the re-used or overlapping frequency bands are not used during the same time period. Similarly, multiple frequency bands can be used during the same time period as long as the frequency bands do not overlap. For example, the resource grants 231-234 represent resource grants to the user terminals 110a, 110b, 110c, where the width of the resource block 231-234 represents its duration in time and the height of the resource block 231-234 represents its frequency span. The resource grant 231 can be assigned to user terminal 110a and the resource grant 232 can be assigned to user terminal 110c, wherein the resource grants 231, 232 are allowed to overlap in time because they span different frequencies. The resource grant 233 can be assigned to user terminal 110a and the resource grant 234 can be assigned to user terminal 110b, wherein the resource grants 233, 234 are allowed to overlap in time because they span different frequencies. Moreover, the resource grants 231, 234 are allowed to have overlapping frequency ranges because they span different time periods. Similarly, the resource grants 232, 233 are allowed to have overlapping frequency ranges because they span different time periods. Further examples of return link channel allocations are described herein with reference to FIGS. 4B, 4C, 5A, and 5B.

FIG. 2C illustrates that the user terminals 110a, 110b, 110c transmit data 114a, 114b, 114c from their buffers in accordance with the time-frequency resources allocated by the scheduler 170. Individual time-frequency resources correspond to a return link channel assigned during a transmit grant time period wherein the return link channel is selected from an RCG at the scheduler 170, the RCG including overlapping return link channels. The user terminals 110a, 110b, 110c transmit data 114a, 114b, 114c to the gateway routing devices 150a, 150b through the satellite network 140a via the return link. It should be understood that multiple gateways (e.g., gateway routing devices 150a, 150b) may be involved in the reception of a burst from individual user terminals 110a, 110b, 110c. After reaching the gateway routing devices 150a, 150b, the data can then be directed to the Internet 160. Data from the Internet 160 can be sent to the user terminals 110a, 110b, 110c by the gateway routing devices 150a, 150b via the forward link of the satellite network 140a. In some embodiments, the scheduler 170 is also configured to manage transmission resources on the forward link of the satellite network 140a, similar to the way the scheduler manages transmission resources on the return link.

### Examples of Overlapping Channelization

As described herein, the disclosed systems and methods provide for defining return link channel partitioning with support for overlapping channels. The disclosed communications systems support many different return link channels that have different transmission characteristics. Return channel groups can be defined that include many or all of the possible return link channels, which results in overlapping return link channels (or return link channels that overlap in frequency) in the RCG.

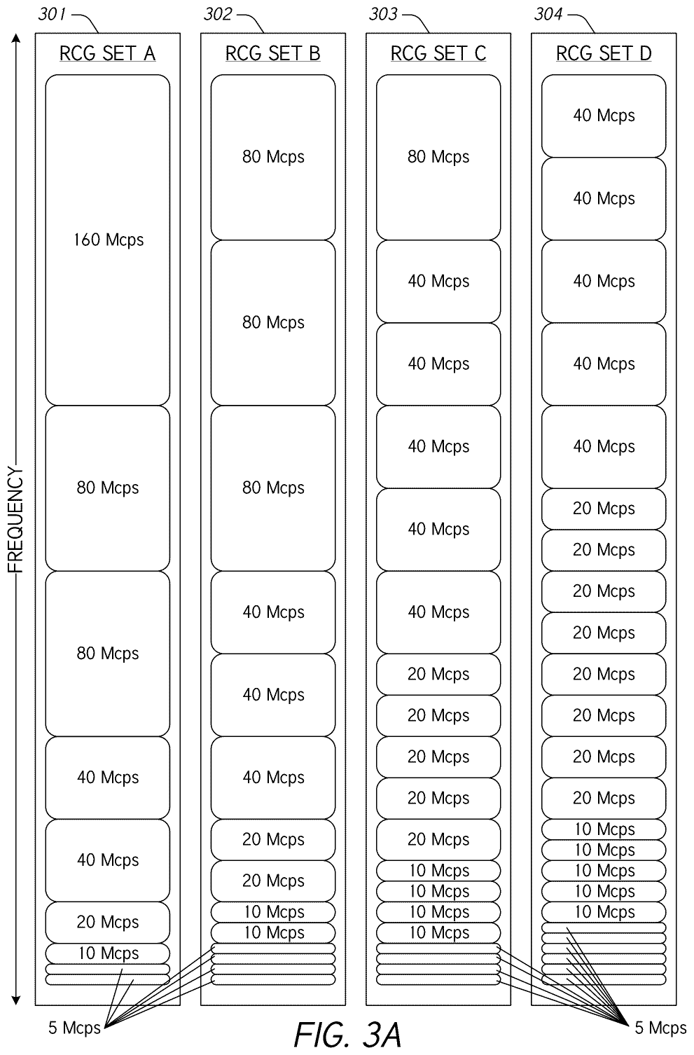

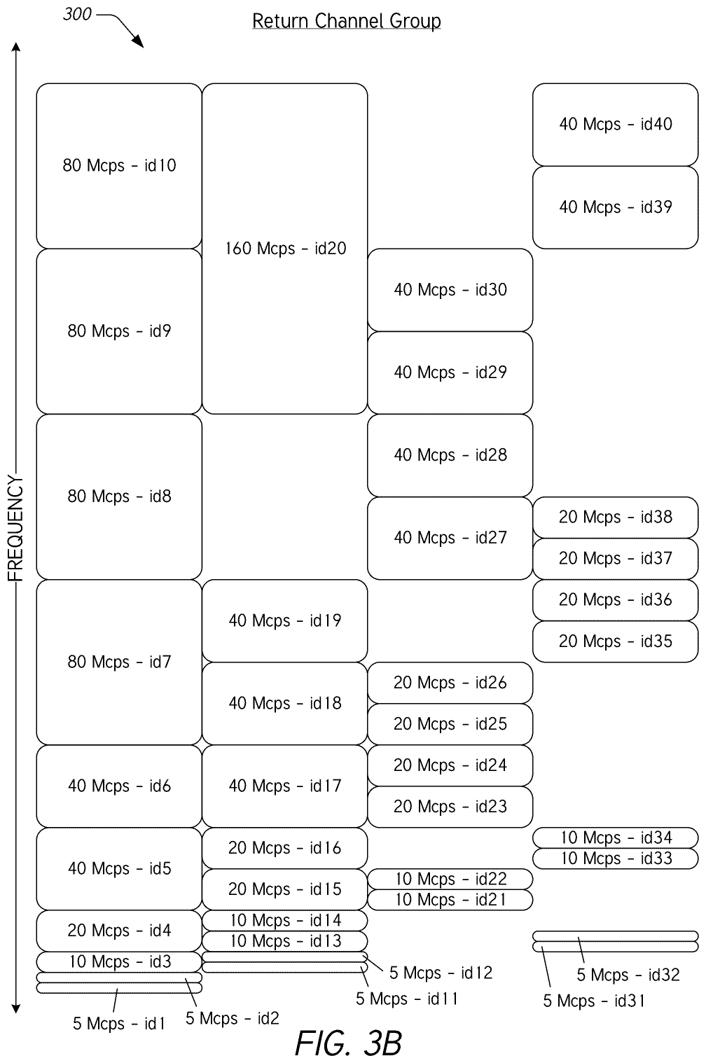

FIG. 3A illustrates an example of a plurality of RCGs 301-304 that each do not include overlapping channels, the plurality of RCGs 301-304 configured for use in certain communications systems. Each RCG set 301-304 defines a different RCG and may be implemented in different situations. For example, during a rain fade event, a communications system may switch from RCG set A 301 to RCG set B 302, RCG set C 303, or RCG set D 304 to accommodate deteriorating transmission characteristics of user terminals. However, as described herein, changing from RCG set A 301 to any of the other RCG sets 302, 303, 304 may take an undesirably long time and may result in inefficient use of return link capacity because it intermittently leaves a portion of the spectrum unavailable for use. As another example, there may be a user terminal capable of higher data rates. To accommodate the higher data rate user terminal, RCG set A may be set as the active RCG. However, while RCG set A is active, if the high data rate user terminal is only sporadically using the 160 Mcps channel, other user terminals that only support lower data rate channels (e.g., 80 Mcps) cannot use the portion of the spectrum reserved for the 160 Mcps channel even when the high data rate user terminal is idle. In such instances, the entire 160 Mcps frequency band remains unused when the high data rate user terminal is not sending return link traffic. With the disclosed overlapping return link channel schemes, the other user terminals can use the portion of the spectrum that may otherwise have been reserved for the 160 Mcps channel, thereby making more efficient use of the return link capacity. Accordingly, the disclosed technologies are configured to utilize an RCG that includes many or all of the possible return link channels, which may overlap, to avoid the need to switch between RCGs during operation.

FIG. 3B illustrates an example RCG 300 that provides many overlapping return link channels that may be useful in communications systems where transmission characteristics may deteriorate due to changes in channel conditions (e.g., bad weather such as rain in a satellite network) and/or where one or more exclusive terminals may create sporadic demands for high throughput return link traffic. The return link channels are uniquely identified using an identifier id1-id40. In some embodiments, the identifier of the return link channel can be used to indicate resource grants from the scheduler to the user terminals.

By way of example, user terminals may be able to transmit using a transmission rate of 80 Mcps during nominal conditions. However, when certain conditions arise (e.g., a rain fade event), these same user terminals may not be able to achieve a transmission rate of 80 Mcps and may only be able to achieve transmission rates of 40 Mcps or 20 Mcps. The RCG 300 allows for rapid utilization of return link channels with reduced bandwidth. A scheduler, such as the scheduler 170 or the scheduler 770, is configured to schedule grants on individual return link channels as applicable depending on channel conditions in the communications system, making use of more lower transmission rate channels as appropriate.

For example, the number of user terminals capable of transmitting at a particular chip rate (e.g., a home channel) varies with channel conditions in a communications system. Under clear sky conditions, most terminals may be able to close the link with the highest chip rate, but during a rain fade event, many terminals may fall to a lower chip rate channel. In addition, the rain event may not be uniformly affecting all user terminals in the system, some terminals may converge to a higher chip rate channel while others settle on a lower chip rate. The RCG 300 advantageously allows the communications system (e.g., the scheduler) to dynamically adapt RCG channelization to accommodate the user terminals in a communications system based at least in part on their preferred home channel. The RCG 300 also provides a flexible configuration that can change with changing conditions that affect the performance of the user terminals in the communications system. The RCG 300 also provides a flexible configuration that can change with changing demands to accommodate high throughput return link traffic in the communications system. In addition, the RCG 400 also advantageously enables switching of return link channels on a time scale that does not create network instability.

FIG. 4A illustrates an example of a return channel group or RCG 400 with one return link channel (id9) that has a frequency band that overlaps two other return link channels (id8 and id10). The return link channels of the RCG 400 are assigned indexes id1-id10 to uniquely identify each return link channel. It should be noted that the indexes are merely one way to identify the return link channels and that other ways may be employed to identify return link channels. For example, a return link channel can be identified using a characteristic frequency (e.g., a center frequency, a lower edge frequency, an upper edge frequency, a frequency offset) and a bandwidth (e.g., a transmission rate, a frequency band width, etc.). Return link channels can be identified or defined using a frequency and a width of the frequency band such as an offset from a frequency band's center frequency and a channel's bandwidth (e.g., in Msps or Mcps or MHZ). The identifiers can be used to identify the corresponding return link channel in the RCG when allocating transmission resources or changing or updating the RCG, for example. By way of example, the RCG 400 includes 10 return link channels id1-id10 with corresponding center frequencies f1-f10. The return link channels id1-id10 also have respective transmission rates of 5 Mcps (id1), 10 Mcps (id2, id3), 40 Mcps (id4, id5), 80 Mcps (id6, id7, id8, and id9), and 160 Mcps (id10).

The RCG 400 is an example of an RCG that may be used in communications systems with one or more exclusive terminals that may create sporadic demands for high throughput return link traffic. In this example, an exclusive user terminal may be capable of maintaining a transmission rate of 160 Mcps under nominal conditions. In response to a demand for high throughput return link traffic, a scheduler (such as the scheduler 170 or the scheduler 770) can assign the return link channel id10 to the exclusive user terminal with the transmission rate of 160 Mcps. When that user terminal does not request return link bandwidth, return link channels id8 and id9 can be assigned without potentially causing transmission bursts to collide.

To illustrate one or more advantages of the RCG 400, an example is presented. Certain user terminals with low transmission rates (e.g., 5 or 10 Mcps) may not function on return link channels with high transmission rates (e.g., 160 Mcps). In some communications systems with certain RCGs (e.g., RCGs with non-overlapping and/or sequential channelization such as those described herein with reference to FIG. 3A), a portion of the channelization is reserved for the high throughput user terminal (e.g., 160 Mcps), such as the RCG 301 in FIG. 3A. This portion of the channelization may then be unavailable to the certain low transmission rate user terminals, leaving a significant fraction of available bandwidth unused when the high throughput user terminal is not transmitting. In the disclosed RCGs with overlapping channelization, the high throughput return link channel can be dynamically assigned without reserving a portion of the bandwidth for high throughput user terminals. This allows low throughput user terminals to utilize the available bandwidth because low throughput return link channels are also defined in the RCG with overlapping channelization (e.g., RCG 400). Then, when the high-speed user terminal requests resources for a transmission burst, the high throughput channel can be assigned, and then usage of the low throughput channels can recommence. To recreate this capability with non-overlapping channelization schemes, a relatively large amount of messaging would be required to propagate changes to the RCG to the user terminals of the communications system. This is undesirable due at least in part to the delay in propagating such changes and/or the potential network instability it may cause.

The RCG 400 is configured so that the 160 Mcps return link channel (id10) can be turned on for select terminals on demand. When demand is absent, return link channel utilization can revert back to a regular channelization plan (e.g., a maximum transmission rate of 80 Mcps). This provides desirable flexible configurability. Furthermore, the disclosed overlapping channelization technology can be used so that the time scale of dynamic return link channelization does not create network instability. The disclosed overlapping channelization technology also reduces the loss of capacity and fairness for non-exclusive terminals.

FIG. 4B illustrates an example resource grant map 410 that assigns different user terminals (labeled UT A, UT B, UT C, and UT D) to different return link channels, the return link channels corresponding to the return link channels in the RCG 400 of FIG. 3A (e.g., RCG channel id4 in the resource grant map 410 corresponds to channel id4 in RCG 400). The horizontal axis represents time such that the allocation blocks 412 represent respective transmit grant time periods. Where there is no allocation of resources, the allocation block says “GAP.” In the resource grant map 410, RCG channel id10 is unused because channels id8 and id9 have been assigned during the time period covered by the resource grant map 410 and channels id8 and id9 overlap with channel id10 of the RCG 400. This may represent the situation in which a high-capacity exclusive terminal has not requested or has not been allocated transmission resources. The resource grant maps described herein are similar to the UL-MAP messages utilized in the IEEE 802.16 set of standards (e.g., the worldwide interoperability for microwave access or WiMAX) which is used to allocate access to an uplink (or downlink) channel. The resource grant maps described herein are simplified to illustrate certain elements of the disclosed technologies but should be understood to also include other information advantageous or necessary to allocate transmission resources. For example, the disclosed resource grant maps can be configured to conform to the WiMAX set of standards for UL-MAPs. In addition, the described resource grant maps specify a subset of channels but should be understood to also include additional channels, where suitable.

FIG. 4C illustrates another example resource grant map 420 that assigns return link channel id10 to a fifth user terminal (UT E) for a portion of the time period covered by resource grant map 420. This may represent the situation in which the high-capacity exclusive terminal has requested and has been allocated transmission resources. In the resource grant map 420, RCG channel id10 is unused during a first time period because channels id8 and id9 have been assigned during the first time period and channels id8 and id9 are unused during a second time period because channel id10 has been assigned during the second time period.

FIGS. 4B and 4C illustrate performance advantages provided by the overlapping channelization technology disclosed herein. Here, the 160 Mcps channel (channel id10) is only employed when the 160 Mcps home channel is selected for the high data rate user terminal (UT E) and the user terminal has return link traffic. At all other times, the overlapping 80 Mcps channels can be used for user terminals with a compatible transmission rate. There is no latency in switching between different RCG configurations because the disclosed RCG configurations allow for overlapping channelization.

FIGS. 5A and 5B illustrate examples of resource grant maps 510, 520 that allocate resource grants by breaking up resource grants within a time slot (FIG. 5A) or by assigning resource grants to a time slot (FIG. 5B). The RCG channelization corresponds to the RCG 400 described herein with reference to FIG. 4A. FIG. 5A illustrates intra-slot allocations in the resource grant map 510. In the resource grant map 510, both 80 Mcps channels and the 160 Mcps channel can transmit bursts in the same time slot because allocations are divided within the time slot. In other words, transmit grant time periods can be shorter than a time slot in the communications system and may be sufficiently short to allocate multiple non-overlapping transmit grant time periods in the same time slot. FIG. 5B illustrates inter-slot allocations in the resource grant map 520. In the resource grant map 520, only the two 80 Mcps channels or the 160 Mcps channel can have bursts in a given time slot because the two 80 Mcps channels overlap with the 160 Mcps channel. In other words, transmit grant time periods can be approximately the same duration as the time slots in the communications system such that the scheduler may not allocate multiple non-overlapping transmit grant time periods in the same time slot.

Methods of Allocating Transmit Resources with Overlapping Channelization

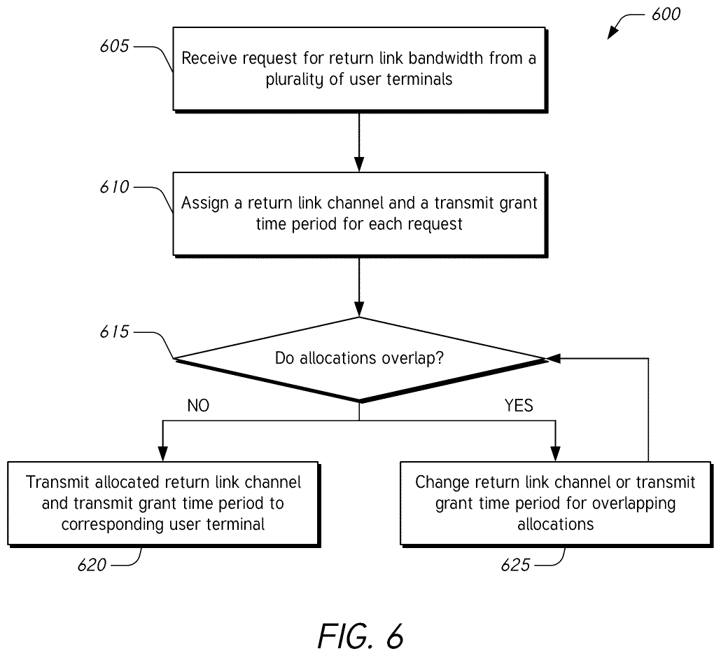

FIG. 6 illustrates a flow chart of an example method 600 of communicating on a communications system that supports return channel groups with overlapping channelization. The method 600 can be performed in any of the schedulers described herein with reference to FIGS. 1A-2C and 7. For ease of description, the method 600 will be described as being performed by a scheduler. This is not to be understood to limit the scope of the disclosure. Rather, any step or portion of the method 600 can be performed by any component or combination of components of the communications systems described herein.

In block 605, the scheduler receives requests for return link bandwidth from a plurality of user terminals. In block 610, the scheduler assigns a return link channel to each requesting user terminal based at least in part on transmission characteristics of the corresponding user terminal. The return link channel is selected from a plurality of return link channels that are grouped together in a return channel group. Each return link channel covers a corresponding frequency band. The scheduler also assigns a transmit grant time period to each requesting user terminal. The plurality of return link channels in the return channel group each have different transmission characteristics in which at least one return link channel has a frequency band that at least partially overlaps a frequency band of another return link channel. In some embodiments, all possible return link channels of the communications system are included in the return channel group.

In block 610, the scheduler determines whether the resource allocations assigned in block 605 overlap. To do this, the scheduler determines whether any frequency band of an allocated return link channel at least partially overlaps with a frequency band of any other allocated return link channel and whether any transmit grant time periods at least partially overlap with any other transmit grant time periods. If the scheduler determines that there are no overlapping allocations, the scheduler communicates the allocated return link channels and associated transmit grant time periods to the corresponding user terminals in block 620. In some embodiments, the scheduler is configured to mark resource grants as taken at the point the resource grant is assigned to avoid assigning overlapping resource grants to another user terminal.

If the scheduler determines that an allocated resource grant has a frequency band and a transmit grant time period that overlaps with another allocated resource grant, the scheduler changes the return link channel and/or the transmit grant time period for one of the overlapping allocations in block 625. The scheduler then returns to block 615 to see if there are more overlapping allocations. This cycle continues until there are no more overlapping allocations.

In some embodiments, the scheduler is further configured to periodically transmit an RCG descriptor message to the plurality of user terminals, the RCG descriptor message comprising an update to the return channel group. The RCG descriptor message can be configured to add a return link channel to the return channel group, to adjust a center frequency of a return link channel in the return channel group, to adjust a bandwidth of a return link channel in the return channel group, or the like.

In some embodiments, the return link channels are assigned based at least in part on the capabilities (e.g., bandwidth, power, etc.) of the requesting user terminal. For example, the scheduler can assign a return link channel to a user terminal where the return link channel has a bandwidth that is greater than or equal to a transmission rate of a corresponding user terminal. The capabilities of the user terminals can be affected by hardware components, such as filters and amplifiers, that impact transmission characteristics, such as power and bandwidth.

In some embodiments, channel conditions of the communications system deteriorate the transmission characteristics of one or more of the plurality of user terminals. In such situations, the scheduler can assign a return link channel based at least in part on the deteriorated transmission characteristics. The deteriorated transmission characteristics may include the transmission rate or the duty cycle of the user terminal.

### Example Scheduler

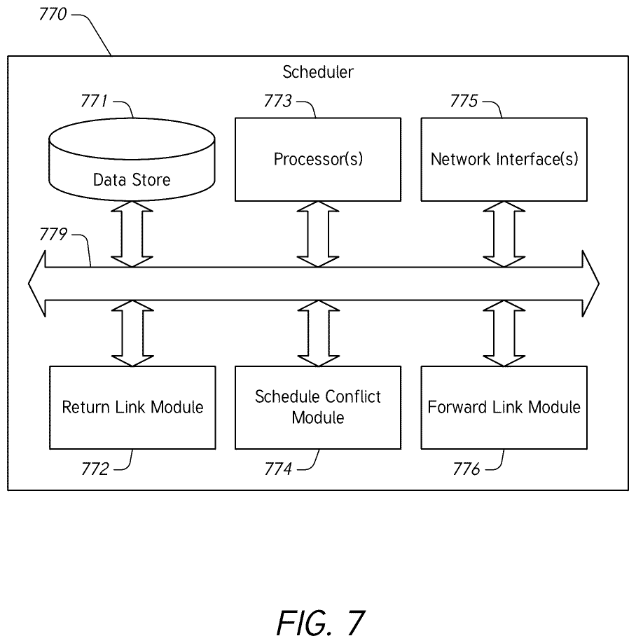

FIG. 7 illustrates a block diagram of an example scheduler 770 configured to allocate resource grants to a plurality of user terminals using a return channel group (RCG) with overlapping channelization. The scheduler is similar to the scheduler 170 described herein with reference to FIGS. 1A-2C and can be implemented in any of the communications systems described herein. The scheduler 770 can employ any method described herein for allocating resource grants using a RCG with overlapping channelization, such as the example method 600 described herein with reference to FIG. 6.

The scheduler 770 can include hardware, software, and/or firmware components for allocating resource grants. The scheduler 770 includes a data store 771, one or more processors 773, one or more network interfaces 775, a return link module 772, a schedule conflict module 774, and a forward link module 776. Components of the scheduler 770 can communicate with one another, with external systems, and with other components of a network using communication bus 779. The scheduler 770 can be implemented using one or more computing devices. For example, the scheduler 770 can be implemented using a single computing device, multiple computing devices, a distributed computing environment, or it can be located in a virtual device residing in a public or private computing cloud. In a distributed computing environment, one or more computing devices can be configured to provide the modules 772, 774, and 776 to provide the described functionality.

The scheduler 770 includes the return link module 772 to assign return link channels and transmit grant time periods to user terminals requesting return link bandwidth. The return link module 772 can be configured to determine suitable return link channels for user terminals from a return channel group that includes a plurality of return link channels with overlapping frequency ranges. Suitability of a return link channel can be based at least in part on transmission characteristics of the user terminals, such as transmission rates.

The scheduler 770 includes the schedule conflict module 774 to analyze allocations to determine if any allocations conflict with one another. A scheduling conflict may be any allocation wherein a frequency band of a first return link channel at least partially overlaps with a frequency band of a second return link channel and the first and second return link channels have been assigned during time periods that at least partially overlap. The schedule conflict module 774 is configured to resolve conflicts by changing one or more allocations using the return link module 772 and may repeat this process until the determined schedule is free from conflicts (e.g., overlapping allocations).

The scheduler 770 includes the forward link module 776 to assign forward link channels and transmit grant time periods to components requesting forward link bandwidth. The forward link module 776 can be configured to determine suitable forward link channels from a channel group that includes a plurality of forward link channels with overlapping frequency ranges. Suitability of a forward link channel can be based at least in part on transmission characteristics of the components or user terminals, such as transmission rates.

The scheduler 770 includes one or more processors 773 that are configured to control operation of the modules 772, 774, 776 and the data store 771. The one or more processors 773 implement and utilize the software modules, hardware components, and/or firmware elements configured to allocate resource grants using an RCG with overlapping channelization. The one or more processors 773 can include any suitable computer processors, application-specific integrated circuits (ASICs), field programmable gate array (FPGAs), or other suitable microprocessors. The one or more processors 773 can include other computing components configured to interface with the various modules and data stores of the scheduler 770.

The scheduler 770 includes the data store 771 configured to store configuration data, analysis parameters, control commands, databases, algorithms, executable instructions (e.g., instructions for the one or more processors 773), and the like. The data store 771 can be any suitable data storage device or combination of devices that include, for example and without limitation, random access memory, read-only memory, solid-state disks, hard drives, flash drives, bubble memory, and the like.

### Additional Embodiments and Terminology

As used herein, the term user terminal may refer to any suitable user equipment that enables communication on the disclosed communications systems. As such, a user terminal may include user equipment or customer premises equipment. As used herein, resource grants, bandwidth grants, and/or return-link grants refer to allocations of transmission resources on a communications system, where a resource can include a time period and a frequency channel. Similarly, as used herein, resource requests, bandwidth requests, and return-link requests refer to requests for transmission resources on a communications system.

As used herein, the term transmission rate can be used to refer to the rate of data transmission over a network and can also be referred to as bandwidth, symbol rate, chip rate, bit rate, or the like. For example, in a Direct-Sequence Spread Spectrum signal, a “chip” is an encoding element. Mcps is a measure of the speed at which chips can be generated by a circuit. In digital communications, a chip may refer to a pulse of a direct-sequence spread spectrum (DSSS) code, such as a pseudo-random noise (PN) code sequence used in direct-sequence code-division multiple access (CDMA) channel access techniques. In some embodiments, chip rate and symbol rate are the same and may be used interchangeably herein.

The present disclosure describes various features, no single one of which is solely responsible for the benefits described herein. It will be understood that various features described herein may be combined, modified, or omitted, as would be apparent to one of ordinary skill. Other combinations and sub-combinations than those specifically described herein will be apparent to one of ordinary skill, and are intended to form a part of this disclosure. Various methods are described herein in connection with various flowchart steps and/or phases. It will be understood that in many cases, certain steps and/or phases may be combined together such that multiple steps and/or phases shown in the flowcharts can be performed as a single step and/or phase. Also, certain steps and/or phases can be broken into additional sub-components to be performed separately. In some instances, the order of the steps and/or phases can be rearranged and certain steps and/or phases may be omitted entirely. Also, the methods described herein are to be understood to be open-ended, such that additional steps and/or phases to those shown and described herein can also be performed.

Some aspects of the systems and methods described herein can advantageously be implemented using, for example, computer software, hardware, firmware, or any combination of computer software, hardware, and firmware. Computer software can comprise computer executable code stored in a computer readable medium (e.g., non-transitory computer readable medium) that, when executed, performs the functions described herein. In some embodiments, computer-executable code is executed by one or more general purpose computer processors. A skilled artisan will appreciate, in light of this disclosure, that any feature or function that can be implemented using software to be executed on a general purpose computer can also be implemented using a different combination of hardware, software, or firmware. For example, such a module can be implemented completely in hardware using a combination of integrated circuits. Alternatively or additionally, such a feature or function can be implemented completely or partially using specialized computers designed to perform the particular functions described herein rather than by general purpose computers.

Multiple distributed computing devices can be substituted for any one computing device described herein. In such distributed embodiments, the functions of the one computing device are distributed (e.g., over a network) such that some functions are performed on each of the distributed computing devices.

Some embodiments may be described with reference to equations, algorithms, and/or flowchart illustrations. These methods may be implemented using computer program instructions executable on one or more computers. These methods may also be implemented as computer program products either separately, or as a component of an apparatus or system. In this regard, each equation, algorithm, block, or step of a flowchart, and combinations thereof, may be implemented by hardware, firmware, and/or software including one or more computer program instructions embodied in computer-readable program code logic. As will be appreciated, any such computer program instructions may be loaded onto one or more computers, including without limitation a general purpose computer or special purpose computer, or other programmable processing apparatus to produce a machine, such that the computer program instructions which execute on the computer(s) or other programmable processing device(s) implement the functions specified in the equations, algorithms, and/or flowcharts. It will also be understood that each equation, algorithm, and/or block in flowchart illustrations, and combinations thereof, may be implemented by special purpose hardware-based computer systems which perform the specified functions or steps, or combinations of special purpose hardware and computer-readable program code logic means.

Furthermore, computer program instructions, such as embodied in computer-readable program code logic, may also be stored in a computer readable memory (e.g., a non-transitory computer readable medium) that can direct one or more computers or other programmable processing devices to function in a particular manner, such that the instructions stored in the computer-readable memory implement the function(s) specified in the block(s) of the flowchart(s). The computer program instructions may also be loaded onto one or more computers or other programmable computing devices to cause a series of operational steps to be performed on the one or more computers or other programmable computing devices to produce a computer-implemented process such that the instructions which execute on the computer or other programmable processing apparatus provide steps for implementing the functions specified in the equation(s), algorithm(s), and/or block(s) of the flowchart(s).

Some or all of the methods and tasks described herein may be performed and fully automated by a computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other non-transitory computer-readable storage medium or device. The various functions disclosed herein may be embodied in such program instructions, although some or all of the disclosed functions may alternatively be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid state memory chips and/or magnetic disks, into a different state.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list. The word “exemplary” is used exclusively herein to mean “serving as an example, instance, or illustration.” Any implementation described herein as “exemplary” is not necessarily to be construed as preferred or advantageous over other implementations.

The disclosure is not intended to be limited to the implementations shown herein. Various modifications to the implementations described in this disclosure may be readily apparent to those skilled in the art, and the generic principles defined herein may be applied to other implementations without departing from the spirit or scope of this disclosure. The teachings of the disclosure provided herein can be applied to other methods and systems, and are not limited to the methods and systems described above, and elements and acts of the various embodiments described above can be combined to provide further embodiments. Accordingly, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

1. A method for communicating in a communications system, the method comprising:
receiving a request for return link bandwidth from a first user terminal and from a second user terminal;
assigning a first return link channel to the first user terminal based at least in part on transmission characteristics of the first user terminal, the first return link channel selected from a plurality of return link channels grouped together in a return channel group, the first return link channel comprising a first frequency band;
assigning a first transmit grant time period to the first user terminal;
assigning a second return link channel to the second user terminal based at least in part on transmission characteristics of the second user terminal, the second return link channel selected from the plurality of return link channels in the return channel group, the second return link channel comprising a second frequency band;
assigning a second transmit grant time period to the second user terminal;
communicating the first return link channel, the first transmit grant time period, the second return link channel, the second transmit grant time period to the corresponding user terminal;
determining whether the first frequency band at least partially overlaps with the second frequency band;
determining whether the first transmit grant time period at least partially overlaps with the second transmit grant time period; and
responsive to determining that the first frequency band at least partially overlaps with the second frequency band and that the first transmit grant time period at least partially overlaps with the second transmit grant time period, assigning a third return link channel to the first user terminal, the third return link channel having a third frequency band that does not overlap with the second frequency band,
wherein the plurality of return link channels in the return channel group each have different transmission characteristics in which at least one return link channel has a frequency band that at least partially overlaps a frequency band of another return link channel.

2. The method of claim 1, wherein the first user terminal has a different transmission rate than the second user terminal.

3. (canceled)

4. (canceled)

5. The method of claim 1 further comprising, responsive to determining that the first frequency band at least partially overlaps with the second frequency band and that the first transmit grant time period at least partially overlaps with the second transmit grant time period, assigning a third transmit grant time period to the first user terminal wherein the third transmit grant time period does not overlap with the second transmit grant time period.

6. The method of claim 1, wherein communicating assigned return link channels and transmit grant time periods to the first and second user terminals is responsive to determining that the first frequency band does not overlap with the second frequency band or that the first transmit grant time period does not overlap with the second transmit grant time period.

7. The method of claim 1, wherein the return channel group is hardcoded in the first user terminal and the second user terminal.

8. The method of claim 1, wherein all possible return link channels of the communications system are included in the return channel group.

9. The method of claim 1, wherein each return link channel in the return channel group has a common center frequency.

10. The method of claim 1, wherein each return link channel in the return channel group has a common lower edge frequency.

11. The method of claim 1 further comprising periodically transmitting a return channel group descriptor message to the first user terminal and to the second user terminal, the return channel group descriptor message comprising an update to the return channel group.

12. The method of claim 11, wherein the return channel group descriptor message adds a return link channel to the return channel group, adjusts a center frequency of a return link channel in the return channel group, or adjusts a bandwidth of a return link channel in the return channel group.

13. The method of claim 1, wherein the first return link channel has a bandwidth that is greater than or equal to a transmission rate of the first user terminal and the second return link channel has a bandwidth that is greater than or equal to a transmission rate of the second user terminal.

14. The method of claim 1, wherein channel conditions of the communications system deteriorate transmission characteristics of the first user terminal, and the first return link channel is assigned to the first user terminal based at least in part on the deteriorated transmission characteristics.

15. A communications system to provide communication over a network, the system comprising:
a first user terminal having a first maximum bandwidth, the first user terminal configured to store a return channel group that comprises a plurality of return link channels;
a second user terminal having a second maximum bandwidth, the second user terminal configured to store the return channel group; and
a gateway configured to communicate with the first user terminal and the second user terminal over the network, the gateway comprising a scheduler configured to:
store the return channel group;
assign a first return link channel from the return channel group to the first user terminal based at least in part on the first maximum bandwidth, the first return link channel comprising a first frequency band;
assign a first transmit grant time period to the first user terminal;
assign a second return link channel from the return channel group to the second user terminal based at least in part on the second maximum bandwidth, the second return link channel comprising a second frequency band;
assign a second transmit grant time period to the second user terminal; and
communicate the first return link channel, the first transmit grant time period, the second return link channel, the second transmit grant time period to the corresponding user terminal;
determine whether the first frequency band at least partially overlaps with the second frequency band;
determine whether the first transmit grant time period at least partially overlaps with the second transmit grant time period; and
responsive to determining that the first frequency band at least partially overlaps with the second frequency band and that the first transmit grant time period at least partially overlaps with the second transmit grant time period, assign a third return link channel to the first user terminal, the third return link channel having a third frequency band that does not overlap with the second frequency band,
wherein the plurality of return link channels in the return channel group each have different transmission characteristics in which at least one return link channel has a frequency band that at least partially overlaps a frequency band of another return link channel.

16. The communications system of claim 15, wherein the network comprises a satellite network with at least one low earth orbit satellite.

17. The communications system of claim 15, wherein the network comprises a satellite network with at least one medium earth orbit satellite.

18. The communications system of claim 15, wherein the network comprises a satellite network with at least one geosynchronous earth orbit satellite.

19. The communications system of claim 15, wherein the network comprises a terrestrial network.

20. The communications system of claim 15, wherein the network comprises a cellular network.

21. The communications system of claim 15, wherein the first maximum bandwidth is different from the second maximum bandwidth.

22. The communications system of claim 15, wherein a duty cycle of the first user terminal is different from a duty cycle of the second user terminal.

23. The communications system of claim 15, wherein the first return link channel is assigned based at least in part on channel conditions that reduce a duty cycle of the first user terminal.

24. The communications system of claim 15, wherein the first return link channel is assigned based at least in part on channel conditions that reduce the first maximum bandwidth.

25. A scheduler in a communications system, the scheduler comprising:
a network interface configured to communicate with a first user terminal and a second user terminal over the communications system;
a data store configured to store computer executable instructions for generating a return link schedule that allocates return link bandwidth to user terminals responsive to requests for return link bandwidth from the user terminals and to store a return channel group comprising a plurality of return link channels; and
a processor configured to execute the computer executable instructions to perform the following:
assign a first return link channel from the return channel group to the first user terminal, the first return link channel comprising a first frequency band;
assign a first transmit grant time period to the first user terminal;
assign a second return link channel from the return channel group to the second user terminal, the second return link channel comprising a second frequency band;
assign a second transmit grant time period to the second user terminal; and
communicate the first return link channel, the first transmit grant time period, the second return link channel, the second transmit grant time period to the corresponding user terminal;
determine whether the first frequency band at least partially overlaps with the second frequency band;
determine whether the first transmit grant time period at least partially overlaps with the second transmit grant time period; and
responsive to determining that the first frequency band at least partially overlaps with the second frequency band and that the first transmit grant time period at least partially overlaps with the second transmit grant time period, assign a third return link channel to the first user terminal, the third return link channel having a third frequency band that does not overlap with the second frequency band,
wherein the plurality of return link channels in the return channel group each have different transmission characteristics in which at least one return link channel has a frequency band that at least partially overlaps a frequency band of another return link channel.

26. (canceled)

27. (canceled)

28. The scheduler of claim 25, wherein, responsive to determining that the first frequency band at least partially overlaps with the second frequency band and that the first transmit grant time period at least partially overlaps with the second transmit grant time period, the processor is further configured to assign a third transmit grant time period to the first user terminal wherein the third transmit grant time period does not overlap with the second transmit grant time period.

29. The scheduler of claim 25, wherein the processor is configured to communicate assigned return link channels and transmit grant time periods to the first and second user terminals responsive to determining that the first frequency band does not overlap with the second frequency band or that the first transmit grant time period does not overlap with the second transmit grant time period.

30. The scheduler of claim 25, wherein all possible return link channels of the communications system are included in the return channel group.

31. The scheduler of claim 25, wherein the processor is further configured to periodically transmit a return channel group descriptor message to the first user terminal and to the second user terminal, the return channel group descriptor message comprising an update to the return channel group.

32. The scheduler of claim 31, wherein the return channel group descriptor message adds a return link channel to the return channel group, adjusts a center frequency of a return link channel in the return channel group, or adjusts a bandwidth of a return link channel in the return channel group.

33. The scheduler of claim 25, wherein the return channel group is a first return channel group and wherein the processor is further configured to assign a first return link channel from a second return channel group to a third user terminal, the second return channel group having a different channelization scheme as compared to the first return channel group.

34. The scheduler of claim 33, wherein the different channelization scheme of the second return channel group comprises a plurality of return link channels different from the plurality of return link channels in the first return channel group.

35. The scheduler of claim 33, wherein the processor is further configured to assign one or more of the plurality of return link channels from the first return channel group to user terminals communicating via a first beam in the communications system and assign one or more of a plurality of return link channels from the second return channel group to user terminals communicating via a second beam in the communications system.
